(19) United States
(12) Patent Application Publication
(10) Pub. No.: US 2003/0079600 A1
(43) Pub. Date: May 1, 2003

(54) Arrangement of a rythmic apparatus with a vehicle sound apparatus, rhythmic accompaniment method and electronic transducer

(75) Inventor: Aurelia Rotolo de Moraes, Curitiba (BR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: AGM - Academia de Ginastica Movel Ltda.

(21) Appl. No.: 10/265,301

(22) Filed: Oct. 4, 2002

Related U.S. Application Data
(63) Continuation of application No. PCT/BR01/00041, filed on Apr. 6, 2001.

(30) Foreign Application Priority Data
Apr. 6, 2000 (BR) P1 0001078-2

(51) Int. Cl. G10H 1/06

(52) U.S. Cl. 84/735

(57) ABSTRACT

An arrangement of a rhythmic apparatus with a vehicle sound apparatus is described, the vehicle sound apparatus generating a first audio signal, the arrangement comprising an electronic module and an electronic transducer the electronic transducer comprising conversion means of vibratory pulses into electrical signals, the electronic module comprising a processing unit having reception means for the signals from de electronic transducer and conversion means of these signals into a second audio signal, the processing unit being associated to a mixer unit having means for the junction of the second audio signal with the first audio signal. The technical sector, which this invention is directed to, is that of the electronics turned to psychology.

### CROSS-REFERENCE TO RELATED APPLICATIONS

This application is a Continuation of International Application PCT/BR01/00041 filed on Apr. 6, 2001, which designated the U.S. and was published under PCT Article 21(2) in English, and which is hereby incorporated herein in its entirety by reference.

### BACKGROUND OF THE INVENTION

1. Field of the Invention

This invention is directed to an arrangement of a rhythmic apparatus with a vehicle sound apparatus, particularly used in the production of sound effects and able to substantially reduce or even eliminate the stressing charge of individuals, mainly when they are inside automotive vehicles for long periods. This invention is directed yet to a rhythmic accompaniment method through the utilization of an electronic transducer, which composes the apparatus. The technical sector to which this invention is directed is that of electronics turned to psychology.

The Patent Application PI 0001078-2 of Apr. 6, 2000 and the Addition Certificates, C1 0001078-2 of Oct. 27, 2000 and C2 0001078-2 of Dec. 8, 2000 of the same applicant and whose inner priorities are herein claimed, describe a rhythmic apparatus and respective method, which are now added of some more technical innovations, which do not change the inventive concept.

2. Description of the State of the Art

The stress combat means known nowadays are based on the natural or allopathic medicine intake and other non natural means, which the individual develops through the potentializing of other addictions, such as the excessive consumption of cigarettes, drinks or drugs, or even the unnecessary intake of colas, candies and sugars in general, in order to aid in healing the anxiety produced by stress.

Other form to combat the stress, broadly spread, is the practice of physical exercises. However, not always it is possible its realization any time, because these demand an appropriate place for their practice.

Studies on stress show its importance, when it was observed that it reaches thousands of people, being one amongst the great responsible for low life quality nowadays. The contemporaneous society has been facing very serious problems, by virtue of stresses, from pressures we suffer daily, from fear we feel, finally from difficulties we try to overcome and, in most of times, we cannot.

These problems will result in what we call stress or yet stress syndrome. The stress is a physiologic reaction which occurs when we need to face a situation which irritate us, scare us, excite us, waste us out, confound us, or even make us immensely happy. The answer to so much stress is that the changes suffered by our society were faster than the evolution of the human body itself. Never the expectations and stresses were so great. We will see the damages the stress causes in traffic.

It is known that the stress interferes in every person from different ways. We can mention some stress symptoms, as for example the discouragement, lack of motivation, the sleep disturbances, the low in self-esteem, the mental tiredness, the depression, the lack of vitality, and, chiefly, the anxiety. In function of this anxiety, the stress occurs, which, as we have seen, causes serious damages to organism. Therefore one great stress generator is the social factor, which generates the traffic in large cities. It is also within the traffic that the feared “Panic Syndrome in Jammed Traffic” occurs, in which the person is led to incontrollable situations.

The vehicle is an instrument of work, hobby, etc, it gives status, but it is one of the places where a person is submitted to several pressures which will lead him/her to have the symptoms above described.

When we enter a vehicle, most of times, we have to wait sit down in the driver and passenger's bench, not being allowed to wake up to walk for a while, not being allowed to park the car in any place and go away, not allowed to do our basic necessities, because we cannot go to a toilet, we cant breath pure air because, in most of times, we are in a place with thousands of other vehicles with their working motors and noticeably polluting the air in that region. Sometimes, we are late and then we start to be stressed. Besides the sum of problems we already bring before entering the vehicle, and which are brooded in our mind, by the time we are inside a car in a traffic jam, which will cause even more stress. Sometimes, we have to bear our bench mate (passenger), who may not share our ideas, and who starts to be a stressing companionship.

By doing an analogy of a stressed person in other situation, for instance, at home. What do we do to dissipate the stress, we go to the kitchen to eat something, we go to the toilet, we go to walk in the garden, we go take a shower/bath, we go to a son's bedroom to chat, we go to lay down in sofa or bed in order to rest, we go to the living room to watch TV, to hear song, to play with the dog, change confidences with the wife, etc.

Then we can see that in vehicles we consider the extension of our home, a symbol of status, a means which take us to new routes, a work tool or a freedom sensation, we do not have the easiness of our home when we need to dissipate the stress. Then, from now, by using the method and rhythmic apparatus, we can significantly reduce the stress level, and we can even eliminate it in many cases, inside the automotive vehicles.

Also within the automotive vehicles we have persons who do not stress but who are hyperactive and they remain with exceeding energy (mainly the young people). Then, to those people have the natural need of keep themselves in movement in order to dissipate this excessive energy, we also recommend the use of this invention.

In the current literature, we can find several works and scientific researches aiming minimize the stressing agents and, thus, reduce the stress effects on people. These works treat, generally, of courses of self-help, reflection, interpersonal relations, aromatherapy, chromo therapy, psychotherapy, vacations, hobbies, massages, vibration medicine, floral therapy, exercises practice, relaxing, nutrition, bio-molecular medicine, acupuncture, do-in, sex, yoga, neuron-linguistic programming, medicines, among others. However, such options are directed to the general situations and non-specific, as it is the case of the stressing social contingency, the vehicles traffic, one of the greatest disturbances of the modern society and which is faced daily by thousands of people.

Unfortunately, the trend is that this traffic worsens continuously, taking alarming proportions. Statistical researches present the stress as the responsible for major part of accidents that occur in cities and roads around the world (directly or indirectly).

The stress caused by great traffic jams in roads and cities trends to take away the good humour of any person. The consequences are severe and the number of automobile accidents cannot stop increasing, as well as the traffic quarrels between stressed drivers who, many times, result in serious corporeal lesions. We can always declare that the need and learning of the human being is reach the longevity and keep the health. Never one has preoccupied so much with health as nowadays.

### BRIEF SUMMARY OF THE INVENTION

This invention has as objective to provide an arrangement of a rhythmic apparatus with a vehicle sound apparatus able to noticeably reduce or even eliminate the stress level in persons confined, for long periods, in automotive vehicles.

Another objective of this invention is to provide an arrangement of a rhythmic apparatus with a vehicle sound apparatus which allows the dissipation of the energy excess in hyperactive people when they are inside the automotive vehicles.

It is still objective of this invention to provide a rhythmic accompaniment method through the use of this arrangement of apparatus.

This invention uses the technical-scientific precepts described in the literary work “Academia de Ginástica Móvel—AGM” (Movable Gym Academy), the author of which is inventor of Method and Apparatus, Aurélio Rótolo de Moraes, which work is registered in Dec. 11, 1997 in the Register of Titles Documents and Legal Entity under n°. 12.107, in the city of Araucária, State of Paraná, from Culture Ministry, in the Authorial Rights office, Record or Registering Certificate n°. 153.191, of the book 251, leaf 296, in the city of Rio de Janeiro, State of Rio de Janeiro.

The scientific precepts described in the literary work above mentioned were evaluated, tested and approved, after 18 months of researches, by a technical staff, headed by Dr. Rosangela Terezinha Cristani Arruda, Psychologist, inscribed in the Psychology Regional Board under n°. 08/2170 in the State of Paraná, the technical-scientific report being registered in the Register of Titles Documents and Legal Entity under n°. 13.479 in Feb. 28, 2000, in the city of Araucária, State of Paraná.

What encouraged this Patent Application was the literary work of this inventor “Academia de Ginastica Móvel—AGM” (which was neither spread) and which means physical and mental exercises within a movable compartment, as, for example, automotive vehicles. Why? Because the accumulated stress inside an automotive vehicle is not easily dissipated and, sometimes, is so much that the vehicle with its occupants is compared to a pressure pot about to blow up.

This invention is directed to an arrangement of a rhythmic apparatus with a vehicle sound apparatus, the vehicle sound apparatus generating a first audio signal, the arrangement comprising an electronic module and an electronic transducer, the electronic transducer comprising means of vibratory pulses conversion into electrical signals, the electronic module comprising a processing unit having reception means of the signals from the electronic transducer and conversion means of these signals into a second audio signal, the processing unit being associated to a mixer unit having means to the junction of the second audio signal to the first audio signal.

This invention yet is directed to a accompaniment rhythmic method of which comprises the steps of choosing the first audio signal in the sound apparatus, choosing a sound timbre from some percussion musical instrument for the second audio signal in the electronic module, emitting the second audio signal through excitation of the electronic transducer and following the first audio signal through the rhythm of the second audio signal.

### BRIEF DESCRIPTION OF THE SEVERAL VIEWS OF THE DRAWING(S)

This invention will be thereafter described in more details based on an example of execution represented in the drawings. The figures show:

FIG. 1 is a block diagram of an arrangement of a rhythmic apparatus with a vehicle sound apparatus, object of this invention;

FIG. 2 is a block diagram of a second embodiment of the arrangement of a rhythmic apparatus with a vehicle sound apparatus;

FIG. 3 is a schematic view of the electronic transducer of the apparatus object of this invention;

FIG. 4 is a schematic view of a second embodiment of the electronic transducer illustrated in FIG. 3;

FIG. 5 is a perspective view of the electronic module of the apparatus object of this invention;

FIG. 6 is a perspective view of a second embodiment of the electronic module illustrated in FIG. 5;

FIG. 7 is a block diagram of a third embodiment of the arrangement of a rhythmic apparatus with a vehicle sound apparatus illustrated in FIG. 1;

FIG. 8 is a perspective view of a third embodiment of the electronic module illustrated in FIG. 5;

FIG. 9 is a schematic view of a third embodiment of the electronic transducer illustrated in FIG. 3;

FIG. 10 is a schematic view of a fourth embodiment of the electronic transducer illustrated in FIG. 3;

FIG. 11 is a schematic view of a fifth embodiment of the electronic transducer illustrated in FIG. 3;

FIG. 12 is a schematic view of a sixth embodiment of the electronic transducer illustrated in FIG. 3;

FIG. 13 is a schematic front view of the remote control of the arrangement of a rhythmic apparatus with a vehicle sound apparatus object of this invention;

FIG. 14 is a block diagram of the connections of the arrangement of a rhythmic apparatus with a vehicle sound apparatus object of this invention;

FIG. 15 is a block diagram of a fourth embodiment of the arrangement of a rhythmic apparatus with a vehicle sound apparatus illustrated in FIG. 1;

FIG. 16 is a block diagram of a fifth embodiment of the arrangement of a rhythmic apparatus with a vehicle sound apparatus illustrated in FIG. 1;

FIG. 17 is a schematic view of a seventh embodiment of the electronic transducer illustrated in FIG. 3;

FIG. 18 is a schematic view of a eighth embodiment of the electronic transducer illustrated in FIG. 3;

FIG. 19 is a schematic view of a ninth embodiment of the electronic transducer illustrated in FIG. 3;

FIG. 19A is a schematic sectional view of the ninth embodiment of the electronic transducer illustrated in FIG. 3;

FIG. 20 is a schematic view of a tenth embodiment of the electronic transducer illustrated in FIG. 3;

FIG. 20A is a schematic sectional view of the tenth embodiment of the electronic transducer illustrated in FIG. 20;

FIG. 21 is a schematic view of a eleventh embodiment of the electronic transducer illustrated in FIG. 3;

FIG. 21A is a schematic sectional view of the eleventh embodiment of the electronic transducer illustrated in FIG. 21;

FIG. 22 is a schematic view of a twelfth embodiment of the electronic transducer illustrated in FIG. 3;

FIG. 22A is a schematic sectional view of the twelfth embodiment of the electronic transducer illustrated in FIG. 21;

FIG. 23 is a schematic perspective view of the ninth embodiment of the electronic transducer illustrated in FIG. 19;

FIG. 24 is a schematic perspective view of the eleventh embodiment of the electronic transducer illustrated in FIG. 21; and

FIG. 25 is a schematic view of the interior of a vehicle and the arrangement of a rhythmic apparatus with the vehicle sound apparatus, object of this invention.

### DETAILED DESCRIPTION OF THE INVENTION

The rhythmic apparatus is based on the mixture of three basic principles, which are: the song, the rhythm and the movement.

The song is a expression means practiced by every person and its therapeutic value is every day more and more spread and explored, once it is produced a great benefit to the person's mind causing a psychic, physical and social welfare sensation. Hardly relaxing exercises are carried out without the sound of song. The song stimulates the functioning of several cerebral regions, as the areas responsible for emotion, memory and motor control.

The rhythm, as one of the song elements, has an extreme importance since through rhythmic repetition it is possible for us to discharge stresses and release ourselves from the daily afflictions.

The movement, in conjunction with the song and the rhythm, is the fundamental base of the relevant apparatus and method.

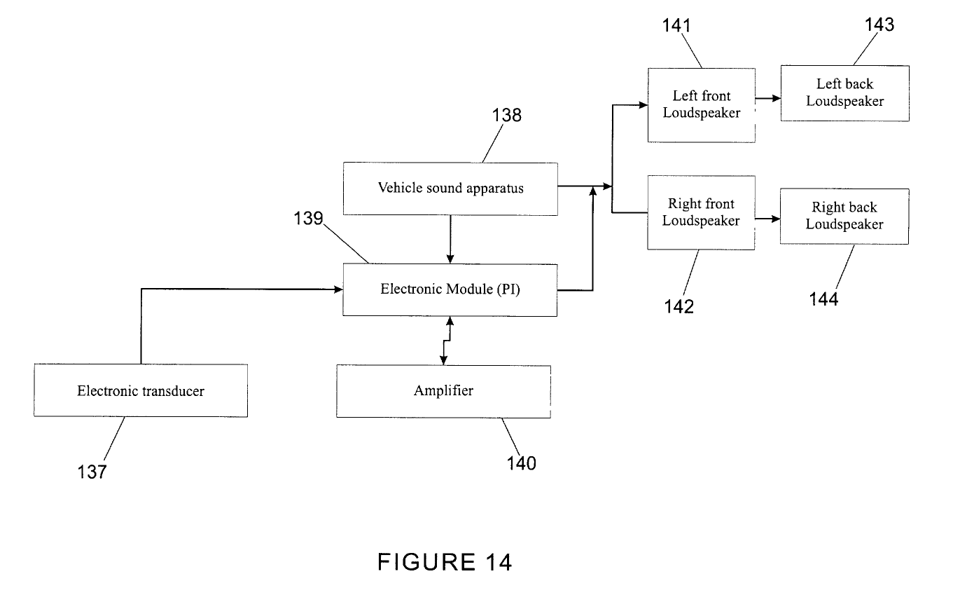

According to a preferred embodiment and as can be seen in FIG. 14, the arrangement of a rhythmic apparatus with a vehicle sound apparatus is formed by electronic module 139, an electronic transducer 137 and an amplifier 140, which are associated to the vehicle sound apparatus 138 and, accordingly, connected to the left front speaker 141, to the right front speaker 142, to the left back speaker 143 and to the right back speaker 144.

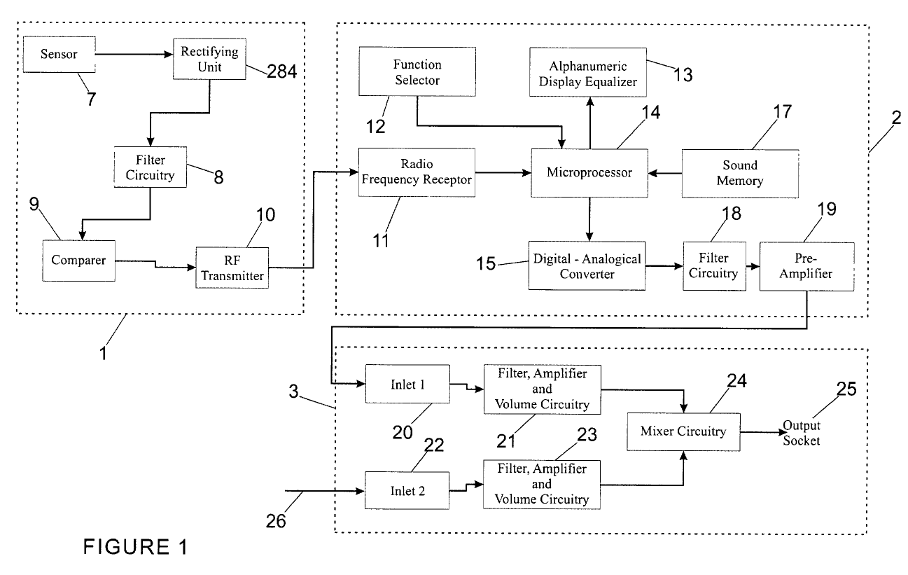

According to FIG. 1, the electronic module 139 comprises an electronic transducer 1, a processing unit 2 and a mixer unit 3.

The electronic transducer 1 has a vibration sensor 7, a rectifying unit 284 a first filter circuitry 8, a comparer 9 and a transmitter 10.

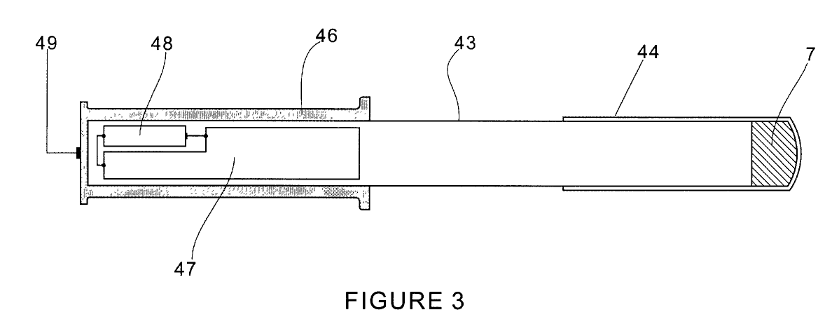

FIG. 3 illustrates a first embodiment of the electronic transducer 1, where this transducer 1 has the shape of a cylindrical drumstick 43 with or without a consistent section, comprised of a rigid polymeric material, for example, PVC, which grants to the transducer 1 feature as lightness, hardness and strength. In this embodiment, the electronic transducer 1 comprises, in a first end, a vibration sensor 7 preferably piezoelectric which is attached to a first transducer 1 end through a cylindrical rubber screened chock 44 and connected to an electronic circuitry 47 positioned to a second transducer 1 end.

This electronic circuitry 47 is comprised preferably of operational amplifiers, radio frequency (RF) transmitter 10 and a 12 Volts battery 48. Also coupled to the circuitry 47 is a on/off button 49.

The transducer 1 still comprises a handle 46 comprised of aired or foamed rubber, coupled to the second end.

When being excited, the vibration sensor 7 emits a signal with electrical pulses of varying frequencies and amplitudes which are rectified in the rectifying unit 284. Thereafter, these pulses are filtered in the first filter circuitry 8 and then sent to the comparer circuitry 9, which compares the signal to pre-established forces levels, so that the digital signal can be defined, which will be emitted by radio frequency transmitter 10 to the processing unit 2.

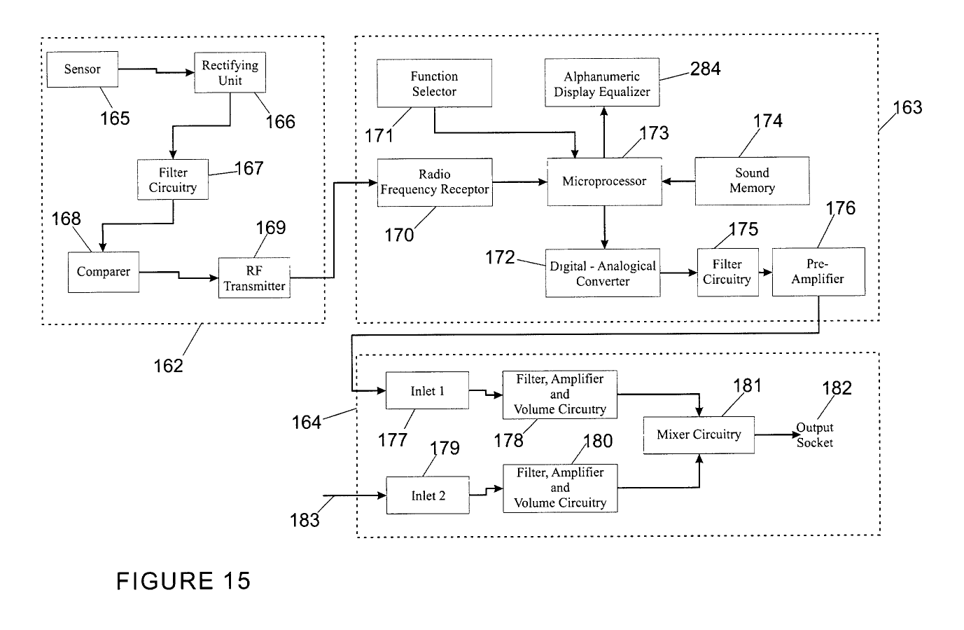

According to FIGS. 1 and 15, the processing unit 2 comprises a radio frequency receptor 11, a function selector 12, a equalizer alphanumeric dial or display 13, a microprocessor 14, a digital-analogical converter 15, sound memory 17, a second filter circuitry 18 and a pre-amplifier 19.

The user selects, in the sound memory 17, a kind of sound of the instrument of his/her preference through the function selector 12. This memory 17 stores, digitally, several kinds of percussion sounds such as, for example, cymbals, bass drum, ximbau, muffled drum, among others. The number or name of the sound kind chosen appears on display 13 and from this choice the unit 2 plays such sound selected with de defined amplitude and according to the excitation frequency designed to the transducer 1.

The processing unit 2 senses the digital signal transmitted by the electronic transducer 1 through the radio frequency receptor 11 and transmits to the microprocessor 14 which, with the excitations pace, forms the rhythmic standards which comprises the accompaniment of some relevant song. The previously chosen sound is converted from digital to analogical 15 passing, thereafter, to the second filter circuitry 18 and afterward to the pre-amplifier 19.

The output signals from the processing unit 2 are sent to the mixer unit 3 which comprises a first inlet 20, a third filter circuitry and volume amplifier 21, a second inlet 22, a fourth filter circuitry and volume amplifier 23, a mixer circuitry A24 and a outlet socket 25.

The mixer unit 3 receives the audio signal from the electronic transducer 1 through the first inlet 20 and mixes it with the audio signal from the vehicle sound apparatus 26 and which enters the unit 3 through the second inlet 22. The audio signal of the first inlet 20 passes through the third filter circuitry and volume amplifier 21 while the audio signal form the second inlet 22 passes by the fourth filter circuitry and volume amplifier 23 and, thereafter, they join together in the mixer circuitry 24. This circuitry A24 generates a mixed audio signal which will get out to the vehicle speakers through the outlet socket 25.

The electronic transducer 1 is fed by a 12 Volts cell, while the processing unit 2 and the mixer unit 3 are fed by the vehicle battery of about 12 Volts.

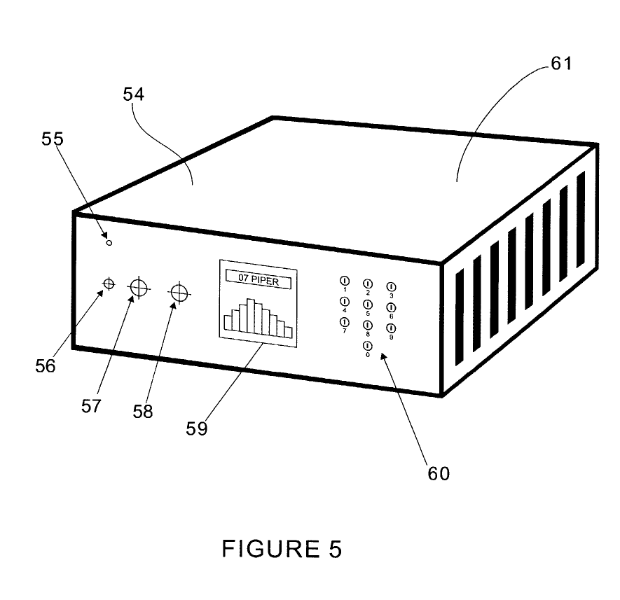

FIG. 5 illustrates the outer portion of the electronic module which is comprised of a plastic or metal lodging box 54 comprising, on one of its faces, a Led 55 indicating that the module is on, an on/off button 56, a vehicle sound volume button 57, a volume button 58 of the transducer 1, an alphanumeric dial or display 59 with equalizer and buttons from 0 to 9 to type the sound number to be chosen.

Inside the box 54 the processing unit 2 and the mixer unit 3 are coupled.

This apparatus is fed by the 12 Volts vehicle battery.

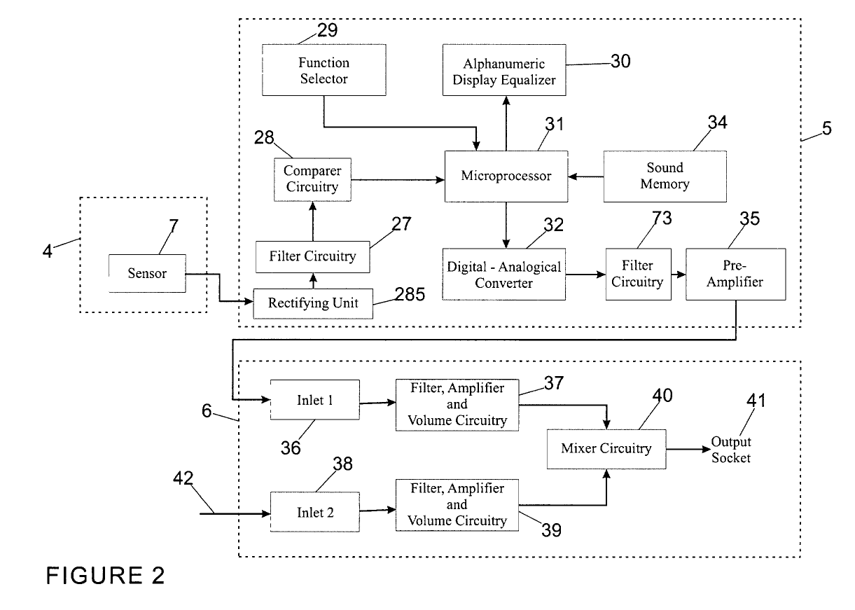

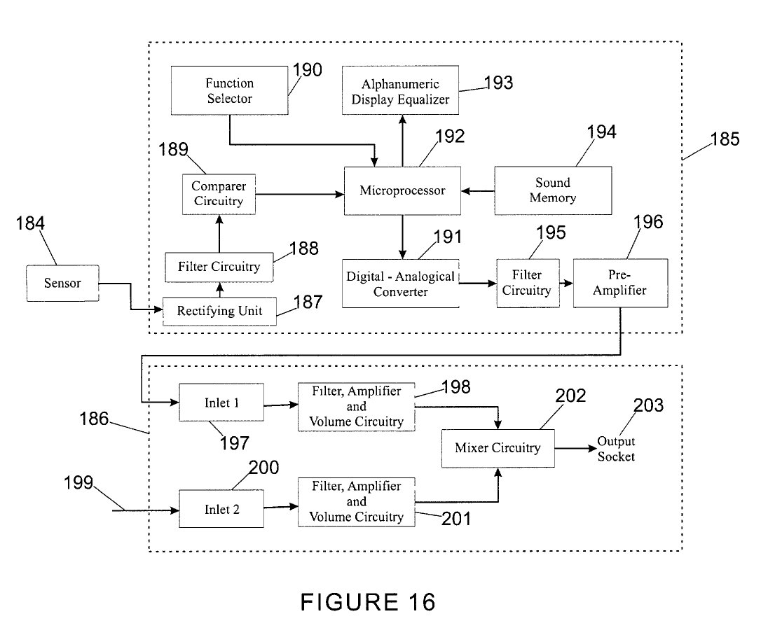

FIGS. 2 and 16 illustrate a block diagram of a second embodiment of the arrangement of a rhythmic apparatus with a vehicle sound apparatus. According to this FIG. 2, the electronic module 139 comprises an electronic transducer 4, a processing unit 5 and a mixer unit 6.

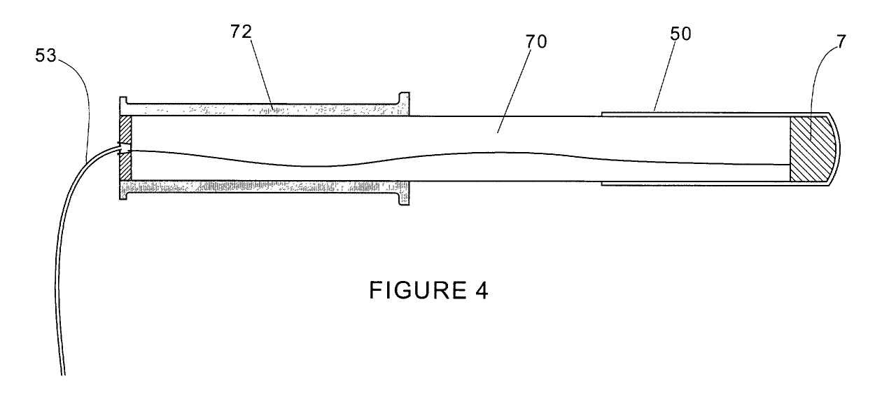

FIG. 4 illustrates a second embodiment of the electronic transducer, in which this transducer 4 has the shape of a cylindrical drumstick 70 with or without a consistent section, comprised of a rigid polymeric material, for example, PVC, which grants to the transducer 4 feature as lightness, hardness and strength. In this embodiment, the electronic transducer 4 comprises, in a first end, a vibration sensor 7 preferably piezoelectric which is attached to a first transducer 4 end through a cylindrical rubber screened chock 44. The sensor 7 is connected to a Jack-type switch positioned in a second transducer 4 end.

The transducer 1 still comprises a handle 72 comprised of aired or foamed rubber, coupled to the second end.

When being excited, the vibration sensor 7 emits a signal with electrical pulses of varying frequencies and amplitudes which are transmitted to the processing unit 5, through transmission by electrical cables 53.

According to FIGS. 2 and 16, the processing unit 5 comprises a rectifying unit 285, a first filter circuitry 27, a comparer circuitry 28, a function selector, a equalizer alphanumeric dial or display 30, a microprocessor 31, a digital-analogical converter 32, sound memory 34, a second filter circuitry 73 and a pre-amplifier 35.

The user selects, in the sound memory 34, a kind of sound of the instrument of his/her preference through the function selector 29. This memory 34 stores, digitally, several kinds of percussion sounds such as, for example, cymbals, bass drum, ximbau, muffled drum, among others. The number or name of the sound kind chosen appears on display 30 and, from this choice, unit 5 plays such sound selected with de defined amplitude and according to the excitation frequency designed to the transducer 4.

The processing unit 5 receives the digital signal transmitted by electronic transducer 4 through cable 53. This signal, with electrical pulses of varying frequencies and amplitudes is rectified in the rectifying unit 285 and, through electrical cables, goes on to the first filter circuitry 27, thereafter being sent to the comparer circuitry 28, which compares this signal to the forces pre-established levels, in order to be defined the digital signal which will be emitted by the processing unit 31.

The excitations pace of the transducer 4 forms the rhythmic standards which composes the accompaniment of some relevant song. The previously chosen sound passes from microprocessor 31, goes to the digital/analogical converter 32, hence to a second filter circuitry 73 and to a pre-amplifier circuitry 35.

The output signals from the processing unit 5 are sent to the mixer unit 6 which comprises a first inlet 36, a third filter circuitry and volume amplifier 37, a second inlet 38, a fourth filter circuitry and volume amplifier 39, a mixer circuitry 40 and a outlet socket 41.

The mixer unit 6 receives the audio signal from the electronic transducer 4 through the first inlet 36 and mixes it with the audio signal from the vehicle sound apparatus 42 and which enters the unit 6 through the second inlet 38. The audio signal of the first inlet 36 passes through the third filter circuitry and volume amplifier 37 and the audio signal form the second inlet 38 pass by the fourth filter circuitry and volume amplifier 39 and, thereafter, they join together in the mixer circuitry 40. This circuitry 40 generates a mixed audio signal which will get out to the vehicle speakers through the outlet socket 41.

The processing unit 5 and the mixer unit 6 are fed by the vehicle battery of about 12 Volts.

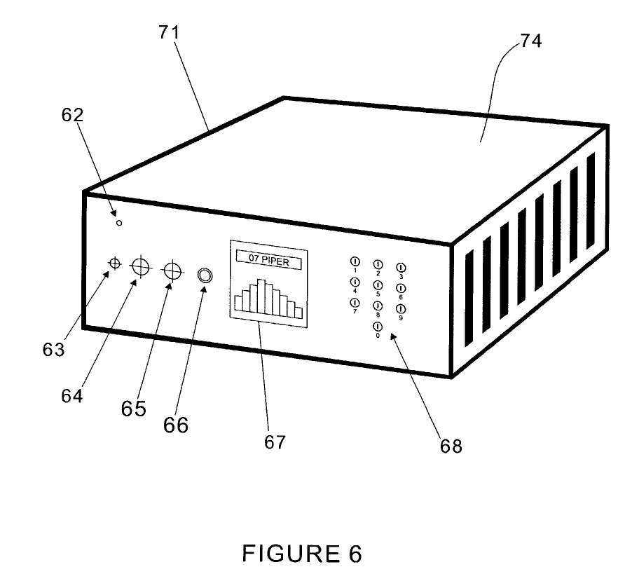

FIG. 6 illustrates the outer portion of the electronic module which is comprised of a plastic or metal lodging box 71 comprising, on one of its faces, a Led 62 indicating that the module is on, an on/off button 63, a vehicle sound volume button 64, a volume button 65 of the transducer 4, a connector 66 which receives the electrical cables from the transducer 4, an alphanumeric dial or display 67 with equalizer and buttons 68 from 0 to 9 to type the sound number to be chosen.

Inside the box 54 the processing unit 5 and the mixer unit 6 are coupled.

This apparatus is fed by the 12 Volts vehicle battery.

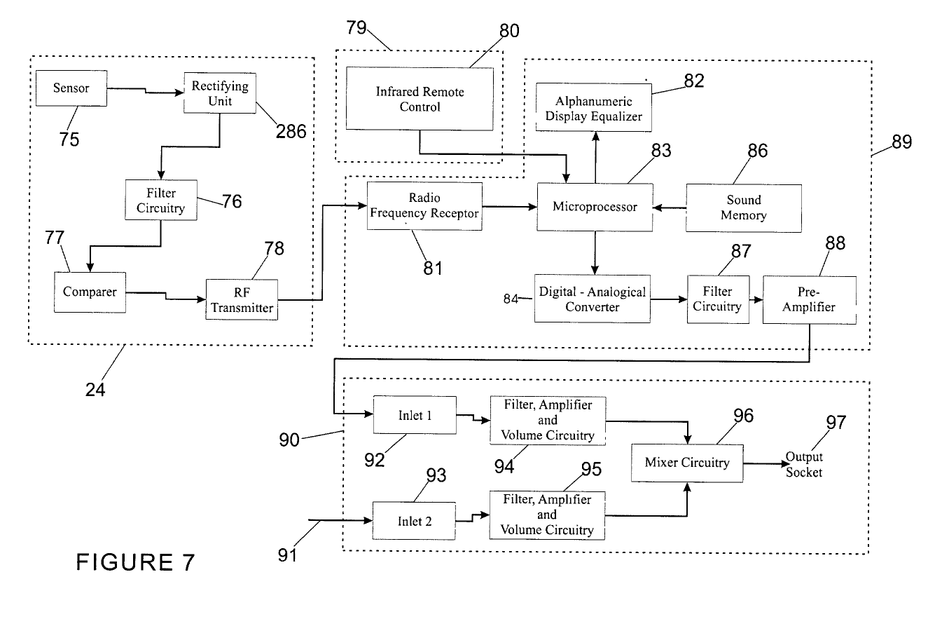

FIG. 7 illustrates a third embodiment of the arrangement of a rhythmic apparatus with a vehicle sound apparatus which has an electronic module 100 which comprises an electronic transducer 24, a processing unit 89, a mixer unit 90 and a remote control circuitry 79.

The electronic transducer 24 has a vibration sensor 75, a rectifying unit 286, a first filter circuitry 76, a comparer 77 and a transmitter 78.

When being excited, the vibration sensor 75 emits a signal with electrical pulses of varying frequencies and amplitudes which are rectified in the rectifying unit 285. Following, these pulses are filtered in the first filter circuitry 76 and then sent to the comparer circuitry 77, which compares the signal to forces pre-established levels so that the digital signal can be defined, which will be emitted by the radio frequency transmitter 78 to the processing unit 89.

According to FIG. 7, the processing unit 89 comprises a radio frequency receptor 81, an alphanumeric equalizer dial or display 82, a microprocessor 83, a digit-analogical converter 84, a sound memory 84, a second filter circuitry 87 and a preamplifier 88.

The processing unit still comprises a stress regulator (not shown).

The user selects, in the sound memory 86, a kind of sound of the instrument of his/her preference through the remote control circuitry 79 which comprises an infrared remote control 80. This memory 86 digitally stores several kinds of percussion sounds such as, for example, cymbals, bass drum, ximbau, muffled drum, among others. The number or name of the sound kind chosen appears on display 82 and, from this choice, unit 89 plays such sound selected with de defined amplitude and according to the excitation frequency designed to the transducer 24.

The processing unit 89 senses the digital signal transmitted by the electronic transducer 24 through the radio frequency receptor 81 and transmits to the microprocessor 83 which, with the excitations pace, forms the rhythmic standards which comprises the accompaniment of some relevant song. The previously chosen sound is converted from digital to analogical 84 passing, thereafter, to the second filter circuitry 87 and afterward to the pre-amplifier 88.

The output signals from the processing unit 89 are sent to the mixer unit 90 which comprises a first inlet 92, a third filter circuitry and volume amplifier 94, a second inlet 93, a fourth filter circuitry and volume amplifier 95, a mixer circuitry 96 and a outlet socket 97.

The mixer unit 90 receives the audio signal from the electronic transducer 24 through the first inlet 92 and mixes it with the audio signal from the vehicle sound apparatus 91 and which enters the unit 90 through the second inlet 93. The audio signal of the first inlet 92 passes through the third filter circuitry and volume amplifier 94 and the audio signal form the second inlet 93 pass by the fourth filter circuitry and volume amplifier 95 and, thereafter, they join together in the mixer circuitry 96. This circuitry 96 generates a mixed audio signal which will get out to the vehicle speakers through the outlet socket 97.

The electronic transducer 24 is fed by a 12 Volts cell, while the processing unit 89 and the mixer unit 90 are fed by the automotive vehicle battery of about 12 Volts.

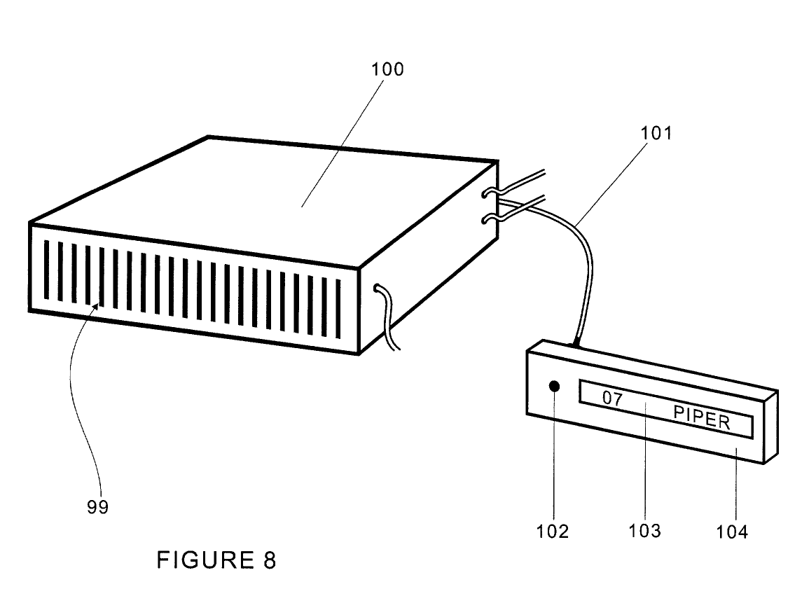

FIG. 8 illustrates an outer portion of the electronic module 100 comprised of a plastic or metal lodging box and which has in one of its faces vent ribs 99.

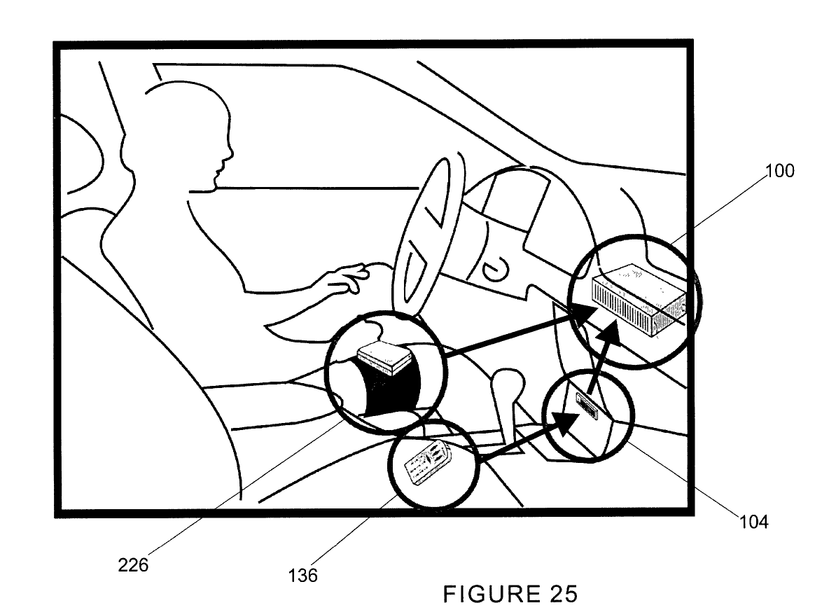

As can be seen by FIG. 25, the module 100 is placed under the vehicle panel, in non apparent place, and connected to a device 104 through electrical cables. Such device 104 is fixed to the panel and comprises an on/off button 102, an alphanumeric dial or display 103 where the number and the name of the selected song will appear through an infrared remote control 136.

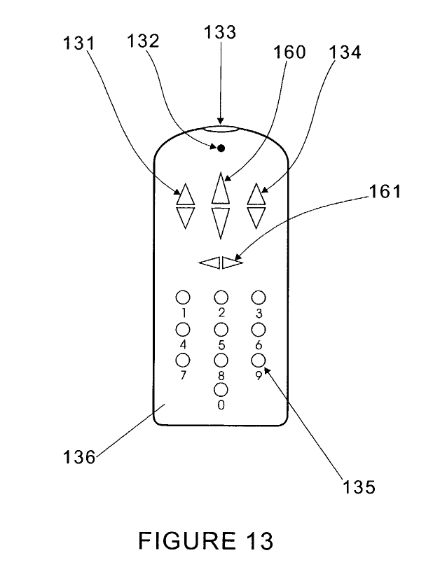

According to FIG. 13, the infrared remote control 136 comprises a plastic box 136, a first selector button 131 of the vehicle sound volume control, a second selector button 134 of the sound volume of the electronic transducer, an on/off button 132, a infrared ray beam emitter receptacle 133, selection buttons 135 of the chosen sound number, a potentiometer 160 and a sequential search device 161.

Through the potentiometer 160, the remote control has the function of sound control after mixed, that is, it controls the sequential search device 161 forward and backward in order to the digital sounds be chosen, it controls the energy supply to the apparatus through the on/off button 132, in addition to control the sound volume both of the transducer 24 and the vehicle sound volume. Such control signals are sent through the infrared ray emission receptacle 133 and received by the remote control circuitry 79.

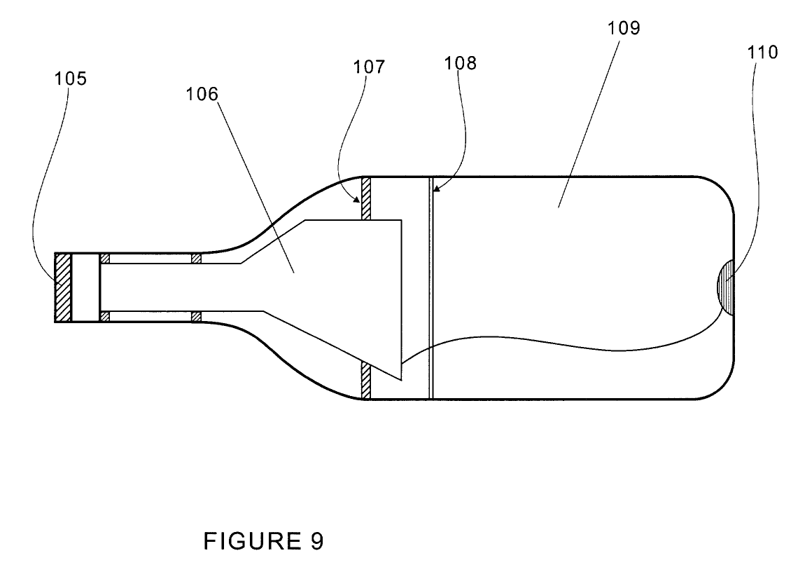

FIG. 9 illustrates a third embodiment of the electronic transducer in shape of bottle 109, made of plastic material similar to the soda or mineral water bottle plastic, having signal transmission means through radio frequency waves to the electronic module 139, more precisely to the processing unit 2.

The bottle-shaped transducer 109 presents a cylindrical shape with varying section, made of a rigid polymeric material and having internally a vibration sensor 110 preferably piezoelectric, attached to the first bottle end through a cylindrical screened rubber shock. The vibration sensor 110 is connected to an electronic circuitry 106 positioned at a second end and kept attached through radial shocks 107 which encloses the circuitry board 106.

This electronic circuitry 106 is preferably composed of operating amplifiers, radio frequency (RF) transmitter and a 12 Volts battery, a comparer circuitry and a filter circuitry. Also coupled to the circuitry 106 is an on/off button positioned in the cap bottle 105 which is split and can be open in the hinge 108. The bottle 109 shall be handled by its smaller section.

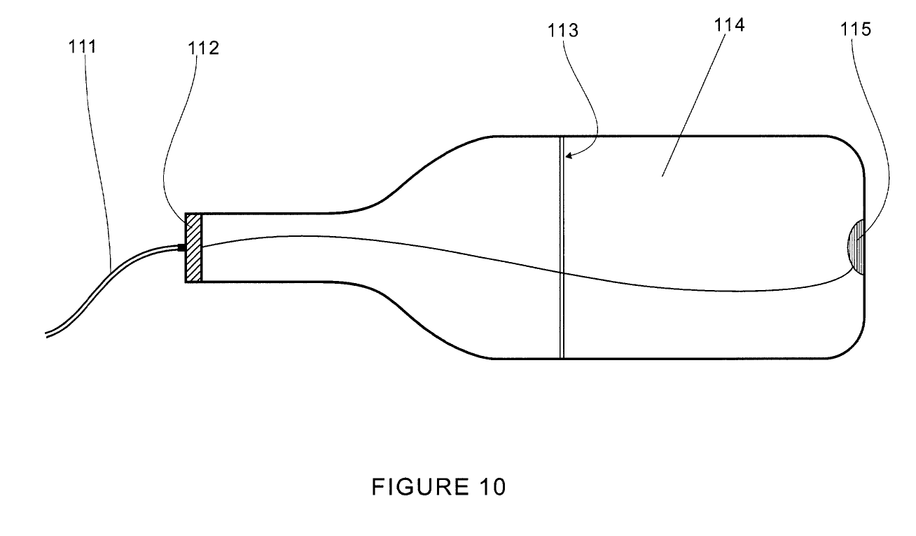

FIG. 10 illustrates a fourth embodiment of the electronic transducer, in which this transducer has the shape of a cylindrical bottle 114 with varying section, made of a rigid polymeric material and having internally a vibration sensor 115, preferably piezoelectric, attached to a first bottle end through a cylindrical screened rubber shock. The vibration sensor is connected to a Jack-type switch proximate to a second bottle end 112 and, through electrical cables 111, this bottle-shaped transducer 114 then will be electrically connected to the electronic module, more precisely to a processing unit 5.

The bottle 114 is split and can be open in the hinge 113. The bottle 114 shall be handled by its smaller section.

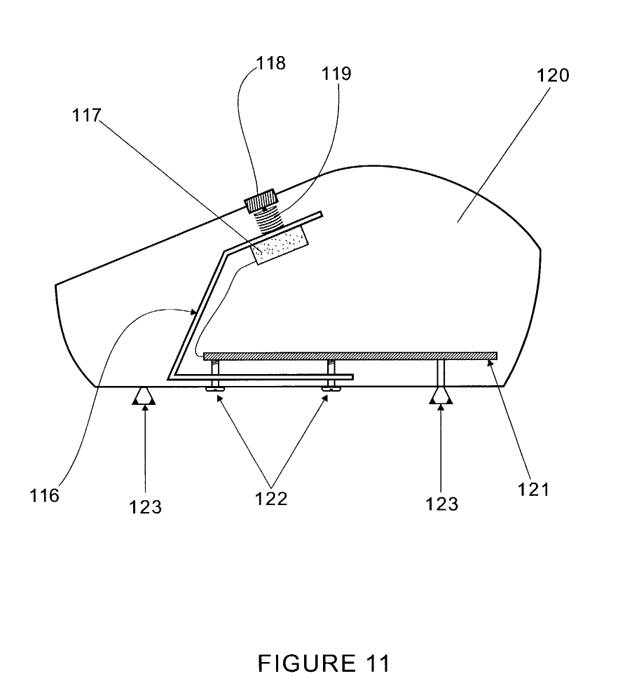

FIG. 11 illustrates an electronic transducer 120 similar to a computer mouse and which transmits electronic signals, emitted by manual touch, through radio frequency waves to the electronic module 139, more precisely to the processing unit 2.

This transducer 120 is comprised of a plastic or metal box, venting support 123 for its fixing to some surface, as for example over the vehicle panel, in the vehicle assent, etc. and an electronic circuitry 121.

The electronic circuitry 121 is preferably composed of operating amplifiers, radio frequency (RF) transmitter 10, a 12 Volts battery 48, a comparer circuitry 9, a first filter circuitry 8, a rectifying unit 284 and other circuitries.

A vibration sensor 117, preferably piezoelectric, is attached to a first inner portion of a flexible board 116. A touch button 118 is fixed on a stainless steel spring 119, in a second outer portion of the flexible board 116, so that it protrudes to the transducer box 120.

The button 118 has the function of receiving the rhythm impact transmitted by rhythmic apparatus user's hands or feet. This impact is absorbed by the button 118 which, in conjunction with the spring 119, moves the flexible board 116. Following, the vibration sensor 117 is excited, transmitting signals to the electronic circuitry 121 which, in turn, will transmit them to the electronic module 139.

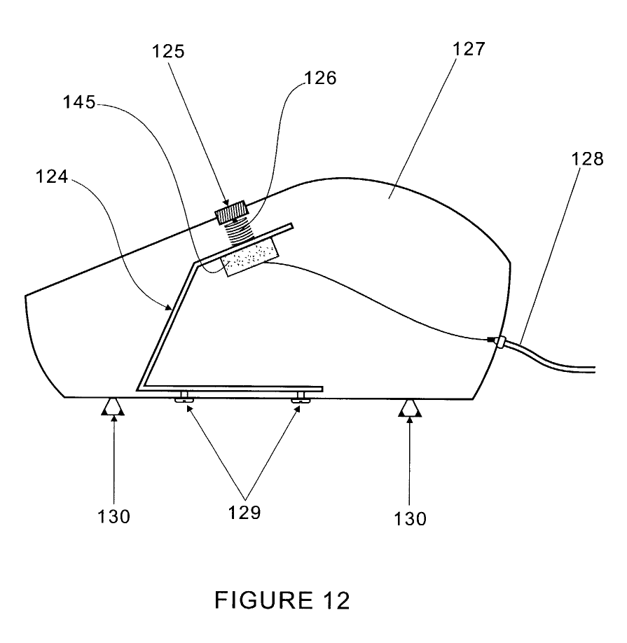

FIG. 12 illustrates an electronic transducer 127 similar to a computer mouse and which transmits the electronic signals, emitted by manual touch, through electrical cables 128 to the electronic module 139, more precisely to the processing unit 5.

This transducer 127 is comprised of a plastic or metal box and venting support 130 for its fixing to some surface and a vibration sensor 145.

This vibration sensor 145, preferably piezoelectric, is fixed in a first inner portion of a flexible board 124. A touch button 125 is fixed on a stainless steel spring 126, in a second outer portion of the flexible board 124, so that it protrudes to the transducer box 127.

The button 125 has the function of receiving the rhythmic impact transmitted by the rhythmic apparatus user's hands. This impact is absorbed by button 125 which, in conjunction with spring 126, moves the flexible board 124. Following, the vibration sensor 145 is excited, transmitting signals to the electronic module 139. Fixating elements 129 grips the flexible board 124 to a lower inner portion of the transducer box 127, proximate to the vents 130.

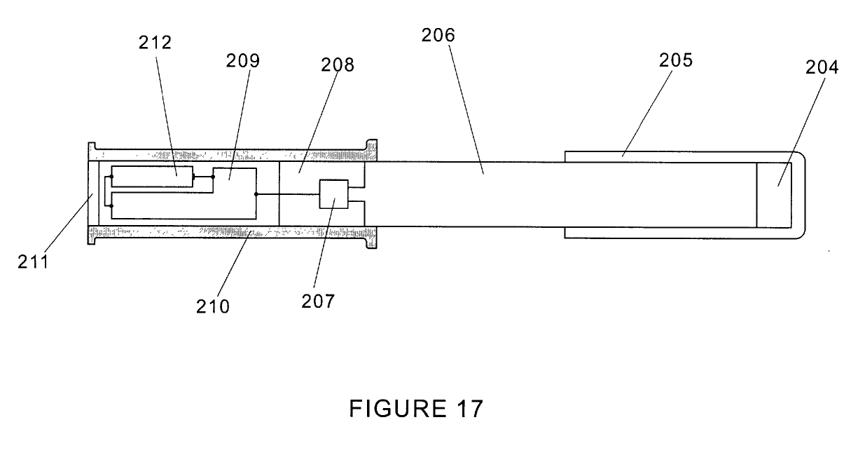

FIG. 17 illustrates a seventh embodiment of the electronic transducer, where this transducer 206 has the shape of a cylindrical drumstick with or without consistent section, made of a rigid polymeric material, for example, PVC, which grants to the transducer 206 feature such as lightness, rigidity and strength. In this embodiment, the electronic transducer 206 comprises, in a first end 205 lined by rubber 204 and a electret vibration sensor 207 fixed in the transducer 206 tube center through a rubber cylindrical shock 208. The electret vibration sensor 207 is connected to an electronic circuitry 209 positioned near to the second transducer 206 end, proximate to a 12 Volts battery 212.

This electronic circuitry 209 is preferably composed of operating amplifiers, rectifying unit, radio frequency (RF) transmitter 10 and a comparer circuitry 9. The handle 210 of the transducer 206 is composed of aired or foamed rubber, while the second end has a rubber shock 211 closing the transducer.

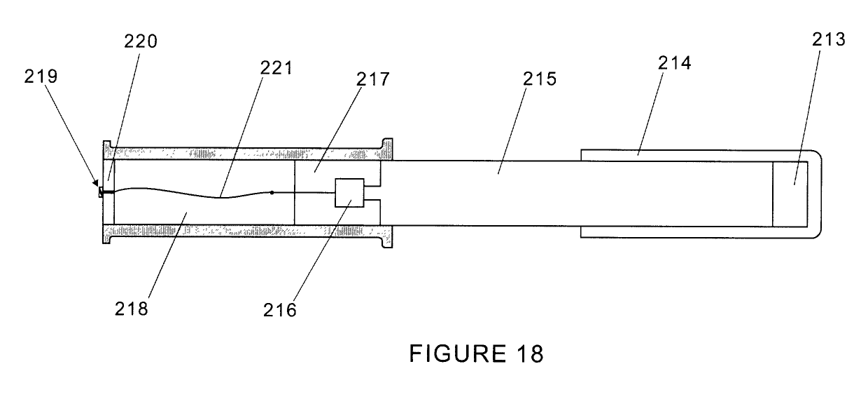

FIG. 18 illustrates an eighth embodiment of the electronic transducer, in which this transducer 215 has a shape of a cylindrical drumstick with or without consistent section, made of a rigid polymeric material, for example, PVC, which grants to the transducer 215 features such as lightness, rigidity and strength. In this embodiment, the electronic transducer 215 comprises, in a first end 213 lined by rubber 214 and a electret vibration sensor 216 attached to the transducer 215 tube center through a rubber cylindrical shock 217. A Jack-type switch 219 is positioned in a second transducer end 215, for the electrical cables 219 connection, which transmit the data emitted by the electret sensor 216 to the module 139.

The handle 218 of the transducer 215 is composed of aired or foamed rubber, while the second end has a rubber shock 220, closing the transducer.

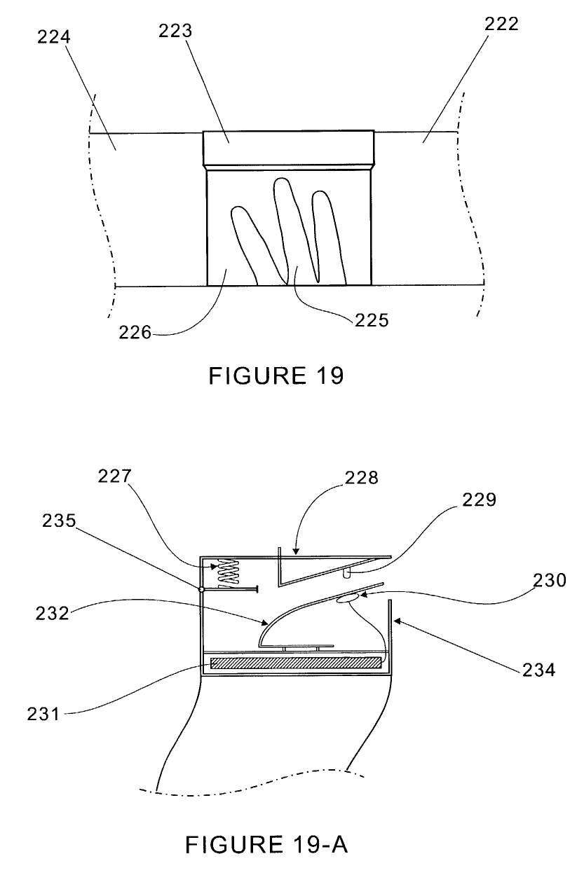

FIG. 19 illustrates a ninth embodiment of the electronic transducer. In this embodiment, transducer 226 emits signals through radio frequency and comprises an touch element which comprises a pad 223 having fixating means 224 and 222 comprising tie beams having adhesive portions made of Velcro®.

As can be seen by FIG. 25, the pad 223 is gripped to the user's body through tie beams 224 and 222. The same can grip it preferably in the thigh or in other places he/she considers convenient.

According to FIG. 19-A, the transducer 226 is comprised of a plastic box 234, a sensitive surface 228 comprising, at least, one touch element, stainless steel springs 227, a pin 229, a flexible board 232, a vibration sensor 230 of type piezoelectric, an electronic circuitry 231 and a labelling shaft 235. Also, the sensitive surface 228 might be provided by two or more touch elements emitting different sounds.

To excite the transducer 226, the user transmits a pressure to the sensitive surface 228, covered by the pad 223, through the impact of his/her fingers 225. This surface 228 absorbs this impact and, through a mild rotation of this surface 228 about the labelling shaft 235, the impact is transmitted to the spring 227, which, in turn, transmits it to the pin 229. Such pin 229 projects on the flexible board 232, which board 232 comprises the vibration sensor 230 fixed in its inner and opposite portion to the region of contact with the pin 229.

The sensor 230 is connected to the electronic circuitry 231. This circuitry comprises the filter circuitry 8, the comparer circuitry 9, radio frequency (RF) circuitry 10, a 12 Volts cell and a rectifying unit 284.

The pad 223 comprises the tie beam 224 positioned in a first end and the tie beam 222 positioned in a second end opposite to the first end.

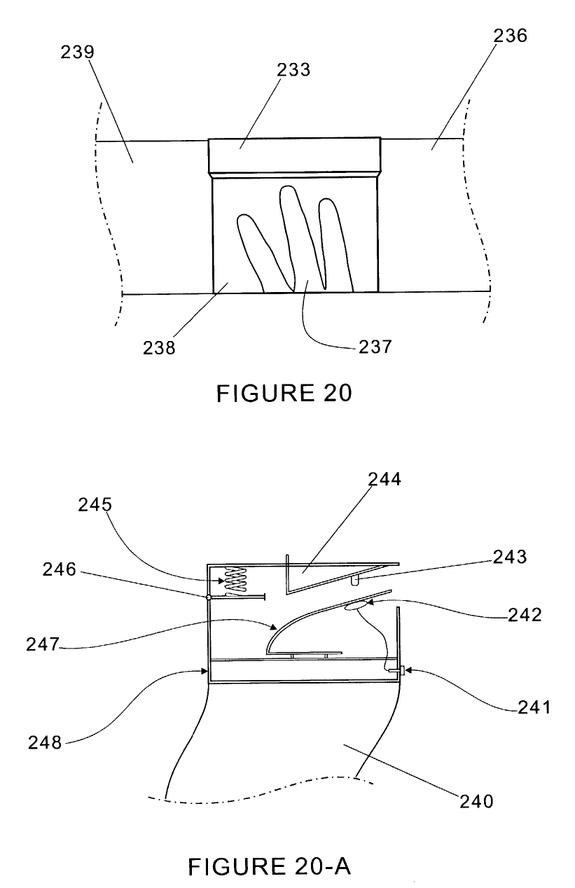

FIG. 20 illustrates a tenth embodiment of the electronic transducer. In this embodiment, the transducer 238 emits signals through the electrical cables (not illustrated) and comprises a pad 233 having fixating tie beams 239 and 240 comprising Velcro® portions.

As can be seen by FIG. 25, the pad 233 is gripped to the user's body through the tie beams 239 and 236. The same can grip it preferably in the thigh or in other places the user considers convenient.

According to FIG. 20-A, the transducer 238 is comprised of a plastic box 248, a sensitive surface 244 comprising, at least, one touch element, stainless steel springs, a pin 243, a flexible board 247, a vibration sensor 242 of the type piezoelectric and a labelling shaft 246. Also, the sensitive surface 244 might be provided by two or more touch elements emitting different sounds.

To excite the transducer 238, the user transmits a pressure to the sensitive surface 244 through the impact of his/her fingers 237. This surface 244 absorbs this impact and, through a mild rotation of this surface 244 about the labelling shaft 246, the impact is transmitted to the spring 245, which, in turn, transmits it to the pin 243. Such pin 243 projects on the flexible board 247, which board 247 comprises the vibration sensor 242 fixed in its inner and opposite portion to the region of contact with the pin 243.

The sensor 242 is connected through electrical cables to a Jack connector 241.

The pad 233 comprises the tie beam 239 positioned in a first end and the tie beam 236 positioned in a second end opposite to the first end.

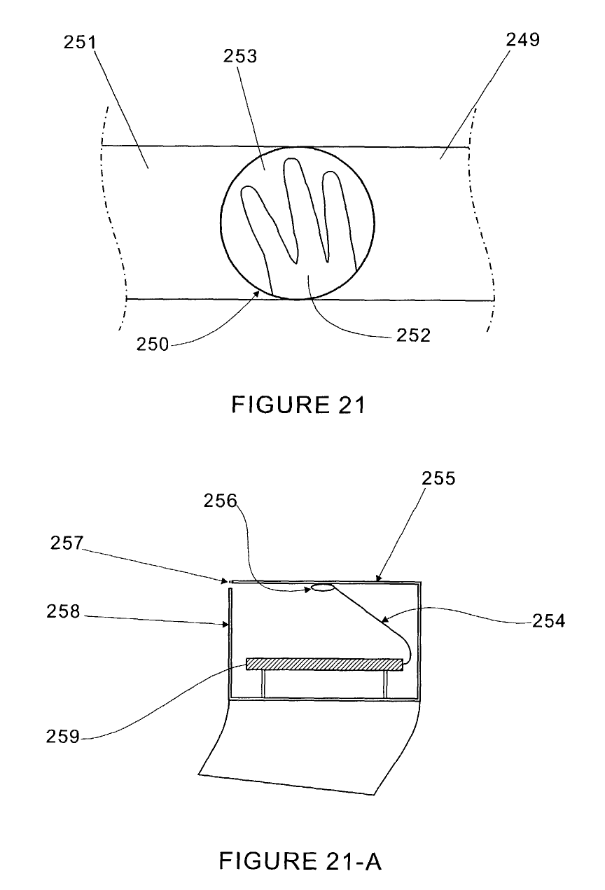

FIG. 21 illustrates a eleventh embodiment of the electronic transducer. In this embodiment, the transducer 250 has the shape of a drum and transmits signals to the electronic module 139 through radio frequency and comprises a pad 253 having fixating tie beams 251 and 249 comprising Velcro® portions.

As can be seen by FIG. 25, the pad 253 is gripped to the user's body through the tie beams 251 and 249. The same can grip it preferably in the thigh or in other places the user considers convenient.

According to FIG. 21-A, the transducer 250 is comprised of a plastic box 258, a sensitive surface 255 comprising, at least, one touch element, which may be a plastic or metallic membrane, stainless steel springs, a pin 243, a flexible board 247, a vibration sensor 256 of the type piezoelectric which is connected by electrical cables 254 to an electronic circuitry 259. Also, the sensitive surface 255 might be provided by two or more touch elements emitting different sounds.

The electronic circuitry 259 comprises the filter circuitry 8, comparer circuitry 9, radio frequency (RF) transmitter, a 12 Volts cell and a rectifying unit 284.

To excite the transducer 250, the user transmits a pressure to the sensitive surface 255 through the impact of his/her fingers 252. This surface 255 absorbs this impact and transmits it to the vibration sensor 256, which is fixed in an inner portion of the surface 255.

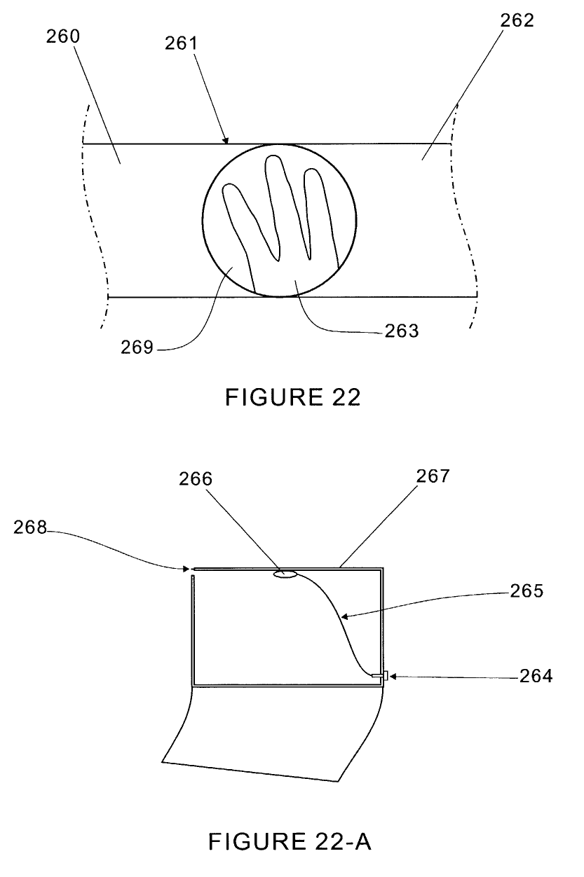

FIG. 22 illustrates a twelfth embodiment of the electronic transducer. In this embodiment, the transducer 261 has the shape of a drum and transmits signals to the electronic module 139 through electrical cables and comprises a pad 269 having fixating tie beams 262 and 260 comprising Velcro® portions.

The pad 269 is gripped to the user's body through the tie beams 262 and 260, as illustrated in FIG. 25. The same can grip it preferably in the thigh or in other places the user considers convenient.

According to FIG. 22-A, the transducer 250 is comprised of a plastic box 268, a sensitive surface 267 comprising, at least, one touch element, which may be a plastic or metallic membrane, a vibration sensor 266 of the type piezoelectric which is connected to electrical cables 264. Also, the sensitive surface 267 might be provided by two or more touch elements emitting different sounds.

To excite the transducer 261, the user transmits a pressure to the sensitive surface 267 through the impact of his/her fingers 263. This surface 267 absorbs this impact and transmits it to the vibration sensor 266, which is fixed in an inner portion of the surface 267. From sensor 266 the data are emitted by electrical cables 264 to the electronic module.

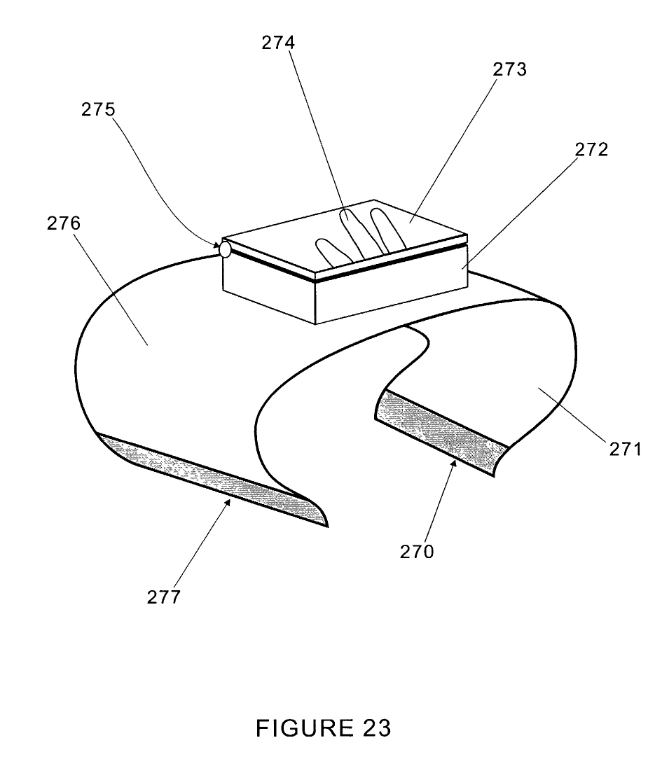

FIG. 23 better illustrates the embodiments of FIGS. 19 and 20, in which the transducer 226 or 228 has a substantially parallelepiped-shaped format, comprising the pad 223 or 233 on the surface 273, where the user, through the contact with the fingers 274, transmits rhythmic movements to the transducer, causing it to move mildly around the labelling shaft 275 and which corresponds to shafts 235 and 246 of FIGS. 19A and 20A, transmitting vibrations to the vibration sensor.

The padded tie beams 276 and 271 illustrate the location of the Velcro® portions 277 and 270.

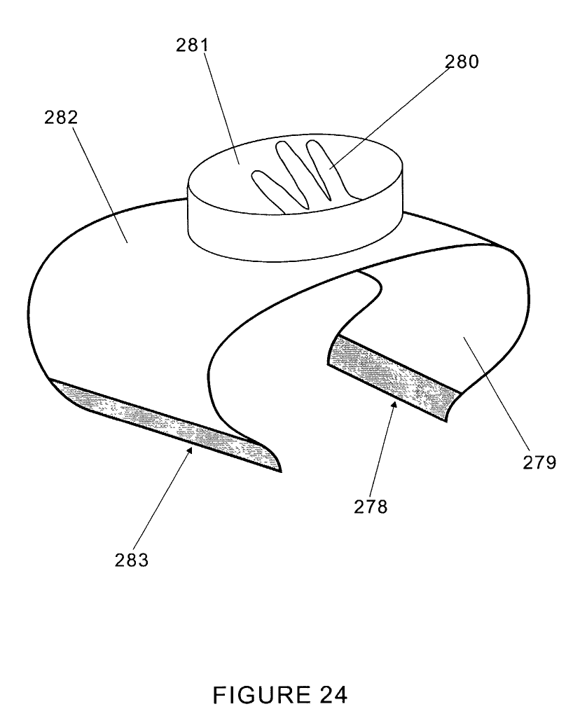

FIG. 24 better illustrates the embodiments of FIGS. 21 and 22, in which the transducer 250 or 261 has a substantially circular shape (drum), comprising the pad 253 or 260 on the surface 281, where the user, through the contact with the fingers 280, transmits rhythmic movements to the transducer, causing the surface 281 to move mildly and transmit vibrations to the vibration sensor.

The padded tie beams 282 and 279 illustrate the location of the Velcro® portions 283 and 278.

Thus, FIG. 25 illustrates the arrangement of the rhythmic apparatus with the vehicle sound apparatus comprising the electronic module 100 placed under the vehicle panel, in a non apparent place, and connected to a device 104, this device 104 being fixed to the vehicle panel. The electronic module 100 and the device 104 are connected to the vehicle sound apparatus 138.

The arrangement of the rhythmic apparatus with the vehicle sound apparatus, as illustrated in FIG. 25, also comprises the infrared remote control 136 that can control the vehicle sound volume control, the sound volume of the electronic transducer, the chosen sound number and a sequential search device, and an electronic transducer 226 that emits signals to the electronic module 100 through radio frequency. The electronic transducer 226 comprises at least one touch element, a pad 223, gripped to the user's body.

Optionally, the electronic module 100 can be manufacture within the vehicle sound apparatus 138 as single part, that is, the vehicle sound apparatus should be made comprising the processing unit and the mixer unit, besides its own ordinary components.

The method of use of the rhythmic apparatus above described comprises the following steps:

a) choosing the first audio signal in the sound apparatus 138;

b) choosing the timbre for the second audio signal in the electronic module 139;

c) emitting the second audio signal through the excitation of the electronic transducer 137; and

d) mixing the first audio signal with the second audio signal 139.

After the installation of module 193 in the automotive vehicle panel, the audio from the original vehicle sound apparatus, which can be radio, cassette player, CD player, MP3 player, minidisk player or other sound player and which are connected to the front and back loudspeakers, starts to be mixed with the sound chosen by the rhythmic apparatus user.

The transducer 1 is connected to the electronic module 139 which is connected to the amplifier 140, to the vehicle sound apparatus and to the loudspeakers. All this assembly is connected, as shown in FIG. 14, and is fed by the automotive vehicle 12V battery.

The user then chooses a rhythmic song, preferably of his/her personal liking, in the vehicle sound apparatus. Following, the same chooses, in the electronic module 139, in its sounds menu, a sound accompaniment which is similar to the instrumental accompaniment of the song of the vehicle sound apparatus.

Handling the transducer 1, the user begins to excite it against any inner surface o the vehicle, or touching with the hand, so that the same emits sounds, for instance, of percussion and which, with the rhythmic repetition similar to that of the song chosen, will cause the user feels himself/herself as member of the band.

The user begins to feel the positive effects of the apparatus. This user's task is to follow the rhythmic measures, both in frequency and intensity, of the song from the vehicle sound apparatus. The rhythmic repetition added to the song, movement of the arms, head, neck, shoulders and further strong messages to the brain, causes the practitioner to feel relaxed and well humoured, in addition to keep him/her concentrated to the song rhythm and in the own rhythmic standard, which sharpens his/her mind, causing him/her to unbosom and forget the difficulties.

Another important aspect of the method is that the same enables to follow a song as if there existed in front of us a percussion instrument with, for instance, eight instruments (cymbals, bass drum, ximbau, muffled drum, etc.), then we would choose only one from eight instruments to follow the song. However, during the song we can follow another instrument (obviously stopping following the previous instrument) then we can see that we have a broad range of options and we attain to draw sounds, with scarce practice, or almost no musical knowledge.

Preference is given to the percussion sounds, because the percussion is rhythmic, whose notes are short.

The sound timber which more is alike some instrument of the song accompaniment (e.g.,: if the song has percussive accompaniment of cymbals, then we also will choose a timbre in the menu sounds stored of cymbals), the sounds timbres of musical instrument of the electronic transducer will exit from the loudspeakers, with different intensity, in conjunction with the sound from the CD player/cassette player or radio, which will be playing the song. We hold the electronic transducer by hand in its handle and we beat it in any surface of the vehicle, and every beat or exciting it will emit a timbre of the musical instrument sound; then we will try to enter with this sound timbre of the musical instrument in rhythm with the rhythm of the song (which is easily attainable, without the need of much practice or musical theory), getting to be tuned, then we will carry out a rhythmic standard, which is similar to that of the song, or at our discretion it can be in our own way (from tribunal of conscience) without the need of being 100% compatible with the song, the rhythm of the sound from the electronic transducer, with some kind of song accompaniment. We can, therefore, follow through the ternary rhythm, which is a strong beat and two weak ones, within the pace of the rhythm, or many other rhythms the person with the elapsing time will attain, forming a rhythmic standard.

One of the benefits of the method is that we feel as if we were members of the musical band, referent to the sound apparatus song. And then keeping on with other song, other more, etc, with the elapsing time, this accompaniment will cause us to become musically more refined and then we can have an audible deeper sensation, noting the several accompaniments which there are in every song; and as if we were experienced musicians, we will be successful in most of songs. The most common of the song accompaniments is the percussive part thereof, but it can be also the part of the strings, blow, keyboard, etc. Also we know about the limitations of the apparatus, which is not musically complete, but we remind that the same is designed to the stress combat and to the pleasure.

Several are the benefits the driver and/or the passengers will have. With the use of the apparatus through the method described, to exteriorise our deepest desires becomes easier, making them acceptable to the ego, because the practitioner venture to draw sounds from his/her apparatus, in the most personal manner as possible.

The individual acquires greater mobility, shows and sharpens its auditory experience and produces a accompaniment of own form, without the need of being of the musical form, more perfect. It is emphasized that it is not necessary to be a song student, or great cognizant thereof, anyone in a minimal time can follow the rhythm (sometimes in own manner) and, thus, dive into the song, and get all the satisfaction and the benefits it grants us. The main apparatus and method feature is that it is considered as a vehicle for emotional self-expression.

The driver and/or the passenger who practices the method with the apparatus will be well ready, well humoured, he/she will be relaxed, accordingly he/she will improve his/her self-esteem (the person simply is happy with himself/herself), he/she will improve his/her motor coordination (because with the apparatus at work the person will movement the arms, moving the muscles, articulations, etc), the welfare sensation will increase and the person recover the lost energy in physical and mental wears, an energization occurs. With the improvement of the self-esteem, the brain commands the production of a chemical substance named endorphin, which is a natural anti-stress, which is launched in the blood stream. People show that the humour sense of someone is directly bonded to the endorphin amount, which is produced by the organism, therefore, the bigger is the production, more well humoured we become, and with a welfare sensation. This sundry of sounds produced stimulate the seratonin liberation by the practitioner, which is a neuron-transmitter involved in the pleasure and relaxation sensations. Then we have the driver calm, then he will be more able to exert the function of driving the vehicle with more safety. The pedestrians will be subjected to smaller possibilities of mistakes, or imprudence of the drivers, then they will be also more preserved.

The drivers will preserve their health and the passengers' one, therefore, that of the adjacent vehicles' passengers and driver.

Thus, when an individual uses the instrument object of this invention, to follow a song of his/her preference, the benefits will be enormous and, when concentrating to follow its rhythm, and when participating thereof, it becomes more possible to dive in a more intense manner into the song and therewith to unbosom himself/herself and forget the difficulties, the accompaniment of the song will act as an expressive channel in which the pressures suffered and the stress are discharged.

Neither the most complex Traffic Laws will have so much success with so small investment, as this method and apparatus, certainly will attain in little time. Then the practitioner driver will come home calm, he will talk to the children, to the wife, to the neighbours, tranquilly, without shouts, without threats, without headache, etc. The same will take place when the driver arrives in his/her work. Therefore, it will help people to be happier and less sick.

Then the use of this invention is recommended to all individuals subjected to the damages of the stress, specifically inside the automotive vehicles, because the method is in plain accordance with the current medical-psychological precepts. It is also indicated to hyperactive persons, to, when practicing the rhythmic accompaniment method, discharge the excess of energy they have (in most cases are the young persons, banging in every place, etc.). It is also indicated as entertainment, sometimes a person who likes song can practice the method/apparatus and spend a lot of time busy, with a pleasant task.

The method, as we have seen, is based on the simultaneous application of the song, rhythm and movement, which make part of its fundamental principle, which, in conjunction with the apparatus, will reach the summit of the system, which is the anti-stress effect. The method also is considered a vehicle for the emotional self-expression. When practicing the method, the person stimulates the functioning of several cerebral regions, as the areas responsible for the emotion, memory and motor control. The functioning of the apparatus, the electronic transducer when excited, will emit a sound which can be of percussion, keyboard, blow or string instrument, therefore by following a song the sound preferably will be only one, when it is not, in the case of a person changes in the course of the song, varying in intensity and frequency, because the relevant apparatus is directed to the combat to the stress, and it is not directed to a musical perfection. The apparatus will be used in automotive vehicles cabinets, for the combat to the stress, or for a pleasant musical entertainment, it can be still used in persons with excess of energy (young persons in general), to dissipate this excess and keep them nicely humoured, or in other situations and occasions. When practicing, by following with the electronic transducer or the sensor, with rhythmic standard, the song will not function in a passive manner as anti-stress remedy, but it will demand that the practitioner participates, generating a flow of musical anticipations. The practitioner more easily exteriorise his/her deepest desires, making them acceptable to the ego, because the practitioner venture to draw sounds from his/her apparatus, in the most personal manner as possible. The practitioner, through rhythmic repetition, will be concentrated to a such extent, to follow the song rhythm, and, to participate thereof, it becomes possible to dive in a more intense form in the song, and therewith to unbosom and forget the difficulties, the song rhythmic repetition will act as an expressive channel, in which the pressures suffered and the stress are discharged.

In the automotive vehicles, the driver can be the only one to use the benefits of the method and apparatus, but we can also have an apparatus to be used by the passenger, when thus they will form a pleasant and unforgettable partnership.

Whereas it has been described an example of a preferred embodiment, it shall be understood that the scope of this invention encompasses other possible variations, being limited only by the content of the appended claims, therein included the possible equivalents.

1. An arrangement of a rhythmic apparatus with a vehicle sound apparatus, the vehicle sound apparatus generating a first audio signal, wherein the arrangement comprises an electronic module and an electronic transducer, the electronic transducer comprising means of vibratory pulses conversion into electrical signals, the electronic module comprising a processing unit having reception means of the signals from the electronic transducer and conversion means of these signals into a second audio signal, the processing unit being associated to a mixer unit having means for the junction of the second audio signal with the first audio signal.

2. An arrangement of a rhythmic apparatus with a vehicle sound apparatus, according to claim 1, wherein the first audio signal is mixed to the second audio signal through a mixer circuitry comprised in the mixer unit.

3. An arrangement of a rhythmic apparatus with a vehicle sound apparatus, according to claim 1, wherein the electronic transducer comprises a vibration sensor of the type piezoelectric.

4. An arrangement of a rhythmic apparatus with a vehicle sound apparatus, according to claim 1, wherein the electronic transducer comprises a vibration sensor of the type electret.

5. An arrangement of a rhythmic apparatus with a vehicle sound apparatus, according to claim 3, wherein the electronic transducer is a cylindrical drumstick, comprised of polymeric material.

6. An arrangement of a rhythmic apparatus with a vehicle sound apparatus, according to claim 3, wherein the electronic transducer comprises the shape of a cylindrical bottle, comprised of polymeric material.

7. An arrangement of a rhythmic apparatus with a vehicle sound apparatus, according to claim 3, wherein the electronic transducer comprises a touch element driven manually or with the feet.

8. An arrangement of a rhythmic apparatus with a vehicle sound apparatus, according to claim 3, wherein the touch element comprises a touch button.

9. An arrangement of a rhythmic apparatus with a vehicle sound apparatus, according to claim 7, wherein the electronic transducer comprises a touch element composed of a pad and fixating means comprised of tie beams comprising adhesive portions.

10. An arrangement of a rhythmic apparatus with a vehicle sound apparatus, according to claim 3, wherein the association of the transducer with the processing unit is done through the radio frequency waves emission and reception.

11. An arrangement of a rhythmic apparatus with a vehicle sound apparatus, according to claim 3, wherein the association of the transducer with the processing unit is done through electrical cables.

12. An arrangement of a rhythmic apparatus with a vehicle sound apparatus, according to claim 1, wherein the processing unit is able to selectively choose a timbre to be applied to the second audio signal.

13. An arrangement of a rhythmic apparatus with a vehicle sound apparatus, according to claim 1, wherein the vehicle sound apparatus comprises at least one loudspeaker.

14. A method of rhythmic accompaniment comprising the steps of:
a) providing a rhythmic apparatus with a vehicle sound apparatus, the vehicle sound apparatus generating a first audio signal, wherein the arrangement comprises an electronic module and an electronic transducer, the electronic transducer comprising means of vibratory pulses conversion into electrical signals, the electronic module comprising a processing unit having reception means of the signals from the electronic transducer and conversion means of these signals into a second audio signal, the processing unit being associated to a mixer unit having means for the junction of the second audio signal with the first audio signal;
b) choosing the first audio signal in the sound apparatus;
c) choosing the timbre for the second audio signal by the processing unit;
d) emitting the second audio signal through the excitation of the electronic transducer;
e) mixing the first audio signal with the second audio signal.

15. An Electronic transducer particularly used with an arrangement of a rhythmic apparatus with a vehicle sound apparatus and comprising means of vibratory pulses conversion into electrical signals, wherein the electronic transducer comprises a sensitive surface comprising, at least, one touch element composed of a pad and fixating means, the means of vibratory pulses being composed of a vibration sensor.

16. An electronic transducer, according to claim 15, wherein the vibration sensor is of the type piezoelectric.

17. An electronic transducer, according to claim 15, wherein the vibration sensor is of the type electret.

18. An electronic transducer, according to claim 15, wherein the fixating means comprise cushioned tie beams with adhesive portions.

19. An electronic transducer, according to claims 15, wherein it is associated to the processing unit through the radio frequency waves emission and reception.

20. An electronic transducer, according to claims 15, wherein it is associated to the processing unit through electrical cables.

21. An electronic transducer particularly used with an arrangement of a rhythmic apparatus with a vehicle sound apparatus and comprising means of vibratory pulses conversion into electrical signals, wherein the electronic transducer comprises a vibration sensor attached to a first inner portion of a flexible board, a touch button fixed on a spring in a second outer portion of the flexible board.

22. An electronic transducer, according to claim 21, wherein comprises an electronic circuitry associated to the second outer portion of the flexible board.

23. An electronic transducer, according to claim 21, wherein the vibration sensor is of the type piezoelectric.
